(19) United States
(12) Patent Application Publication
(10) Pub. No.: US 2017/0061503 A1
(43) Pub. Date: Mar. 2, 2017

(54) Method for Managing and Distributing Interactive Advertisements

(71) Applicant: David R. Sun, Placentia, CA (US)

(72) Inventor: David R. Sun, Placentia, CA (US)

(21) Appl. No.: 14/841,206

(22) Filed: Aug. 31, 2015

(51) Int. Cl. G06Q 30/02; G07F 17/32

(52) U.S. Cl. CPC G06Q 30/0277; G06Q 30/0242; G06Q 30/0273; G07F 17/329

(57) ABSTRACT

A system and method for clients to generate, manage, and send interactive advertising to a plurality of users or consumers. A client, a server, and at least one user device interact with one another over a pre-existing communication network such as the internet. The client generates an interactive advertising campaign by uploading selected media to a server via a web site. The client may also set a plurality of settings associated with the interactive advertising including the age range of individuals the advertisement is to be sent to, the location of individuals the advertisement is to be sent to, among others. The server then distributes the interactive advertisement to the determined user devices through the context of a game application. Results of the consumers interacting with the game application is stored and tracked for the client. The client may also update the settings associated with the interactive advertising at any time.

### BACKGROUND

Field of the Technology

The invention relates to the field of systems and methods of distributing advertising, specifically managing the distribution of advertising through an interactive game over a network.

Description of the Prior Art

Currently, smart devices such as cell phones and tablets are ubiquitous and have achieved a level of such commonality that nearly every person has had some sort of experience with their use. Many of these individuals use a smart device in order to access and run applications or “apps” which are stored software programs on the smart device which allow a user to perform various tasks or activities. Apps can relate to nearly any type of subject matter including traffic or weather information, shopping, streaming music, or even the calibration of precise diagnostic tools. One key use of apps however is that of video games and game related entertainment. Every day, millions of people play an interactive video game on their respective smart device by logging on to a server over a mobile internet network. The server typically not only tracks or sends information to the individual so that they may interact with the app, but also sends the individual or player selected advertising which the player is forced to view or hear. In fact, many apps which are free to download and play depend on in-game advertising in order to generate revenue for the developer of the app.

Advertising within apps are typically delivered in a “banner ad” which is displayed on a portion of the screen of the smart device. The banner ad may also take up the entirety of the screen and force the user to minimize or close the ad in order to resume their interaction with the app. Other advertising options include playing a short advertisement which may comprise a video segment to the user and allowing the user to continue their interaction with the app only after the video has concluded. Like how advertising is done on television or in radio, an advertiser who wishes to advertise their product or service through a developer's application forms a contract with that developer in which in exchange for a determined amount of money, the developer will allow the advertiser to display their ad for a selected duration of time or possible for a predetermined number of views or “clicks.” While this method is effective for distributing advertising generally, like in other forms of media however the user generally does not form a relationship with the advertising since the user is for the most part passively viewing or looking at the ad. From the advertiser's point of view, this is undesirable since such a method of distribution risks the chance that once the advertising has disappeared from the user's interface, it is no longer in the user's mind and thus decreases the chances the user will follow up and purchase the product or service which is advertised.

What is needed therefore is a system and method for generating, managing, and distributing advertising across a mobile online network which is more likely to generate a long lasting and influential relationship with a user viewing the advertisement on a smart device.

### BRIEF SUMMARY

The invention provides for a method for distributing interactive advertising. The method includes receiving uploaded media from a client over a computer based network at a server, receiving a plurality of inputs from the client over the computer based network at the server, and generating a cost estimate based upon the received uploaded media and plurality of inputs by the server. The method further includes generating a plurality of interactive advertisements according to the received uploaded media and plurality of inputs by the server, and then distributing the plurality of interactive advertisements to a plurality of user devices according to the plurality of inputs received from the client.

In one embodiment, the method step of generating a plurality of interactive advertisements according to the received uploaded media and plurality of inputs includes generating a plurality of interactive advertisements which itself includes an interactive scratcher card, at least one goal icon disposed on the scratcher card, at least one scratcher icon disposed on the scratcher card; and at least one prize icon disposed on the scratcher card. The method further stipulates wherein receiving uploaded media from a client over a computer based network at a server includes receiving uploaded media which corresponds to the scratcher card, the at least one goal icon, the at least one scratcher icon, or the prize icon.

In a further embodiment, the method step of generating a plurality of interactive advertisements according to the received uploaded media and plurality of inputs includes inserting the uploaded media into a pre-selected position designated for the scratcher card, the at least one goal icon, the at least one scratcher icon, or the prize icon.

In another embodiment, the method step of receiving a plurality of inputs from the client over the computer based network at the server includes receiving a plurality of parameters selected by the client related to the plurality of user devices the plurality of interactive advertisements are to be distributed to. The embodiment further includes where generating a cost estimate based upon the received uploaded media and plurality of inputs by the server includes the server automatically generating a cost estimate according to the plurality of parameters selected by the client and sending the generated cost estimate to the client. In a related embodiment, the method step of distributing the plurality of interactive advertisements to a plurality of user devices according to the plurality of inputs received from the client is done by distributing the plurality of interactive advertisements to the plurality of user devices according to the received plurality of parameters selected by the client. In yet another related embodiment, the method step of the plurality of parameters being selected by the client related to the plurality of user devices comprises at least one of the following: an age range associated with a user of each of the plurality of user devices, an ethnicity associated with the user of each of the plurality of user devices, a profession associated with the user of each of the plurality of user devices, a current physical location associated with the user of each of the plurality of user devices, or a total number of interactive advertisements which are to be distributed.

In a separate embodiment the method further includes receiving a status indicator from at least one of the plurality of user devices indicating that at least one scratcher icon disposed on the interactive scratcher card matches at least one goal icon disposed on the scratcher card at the server. The method further includes the server marking the received status indicator as a winning item when at least three scratcher icons disposed on the scratcher card match at least three goal icons disposed on the scratcher card at the server. The server then notifies the client of how many out of the distributed interactive advertisements have been marked as winning items.

In yet another embodiment, the method further includes receiving a second set of uploaded media or a second plurality of inputs from the client over the computer based network at the server and automatically generating a second cost estimate based upon the received second set of uploaded media or second plurality of inputs. In this embodiment, the method step of generating a plurality of interactive advertisements according to the received uploaded media and plurality of inputs includes inserting the second set of uploaded media into a pre-selected position designated for the scratcher card, the at least one goal icon, the at least one scratcher icon, or the prize icon. Relatedly, the method step of receiving a plurality of inputs from the client over the computer based network at the server includes receiving a second plurality of parameters selected by the client related to the plurality of user devices the plurality of interactive advertisements are to be distributed to. This embodiment further contemplates that the method step of generating a cost estimate based upon the received uploaded media and plurality of inputs by the server includes the server automatically generating a cost estimate according to the second uploaded media or second plurality of inputs selected by the client and sending the generated cost estimate to the client. Additionally, in this embodiment the method of distributing the plurality of interactive advertisements to a plurality of user devices according to the plurality of inputs received from the client involves distributing the plurality of interactive advertisements to the plurality of user devices according to the received second plurality of parameters selected by the client.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The disclosure can be better visualized by turning now to the following drawings wherein like elements are referenced by like numerals.

### BRIEF DESCRIPTION OF THE DRAWINGS

FIG. 1 is a schematic diagram representing the relationship between a server, the client, and a user device when performing the method of the current invention.

FIG. 2 is a simulated screen image of a scratcher card distributed to the plurality of user devices by the method of the current application.

FIG. 3 is a flow chart of the procedural process carried out by the method of the current invention.

The disclosure and its various embodiments can now be better understood by turning to the following detailed description of the preferred embodiments which are presented as illustrated examples of the embodiments defined in the claims. It is expressly understood that the embodiments as defined by the claims may be broader than the illustrated embodiments described below.

### DETAILED DESCRIPTION OF THE PREFERRED EMBODIMENTS

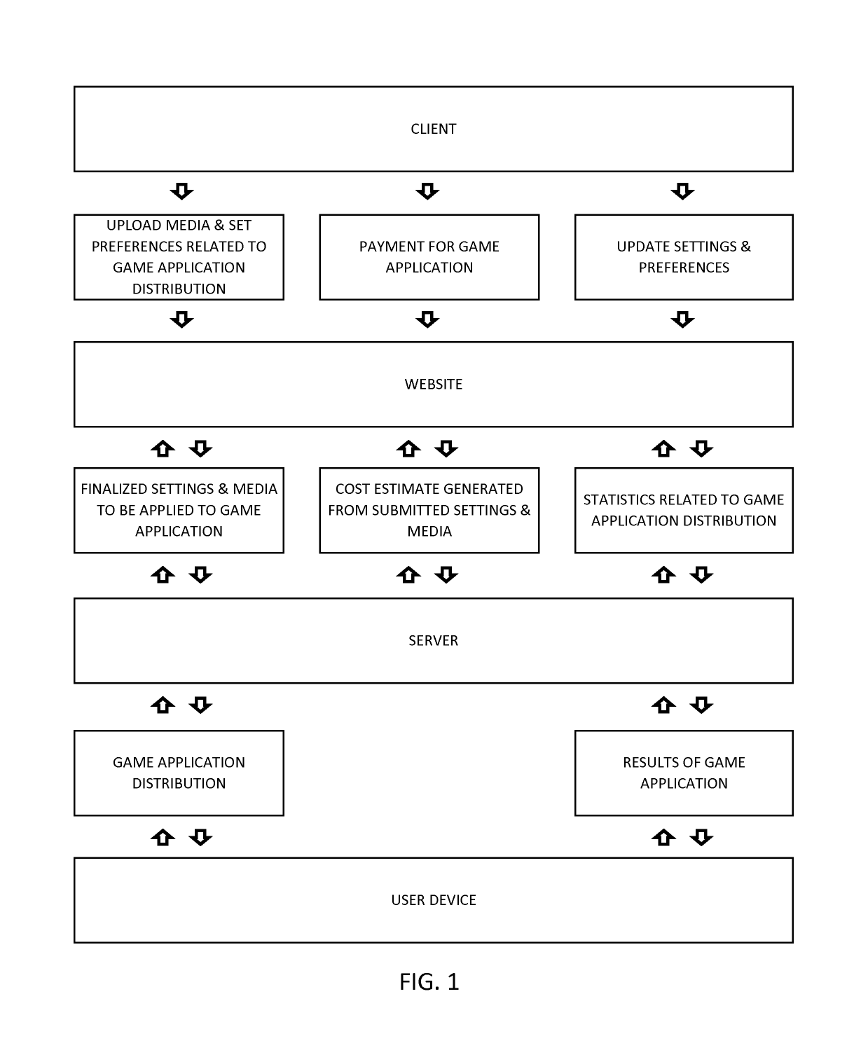

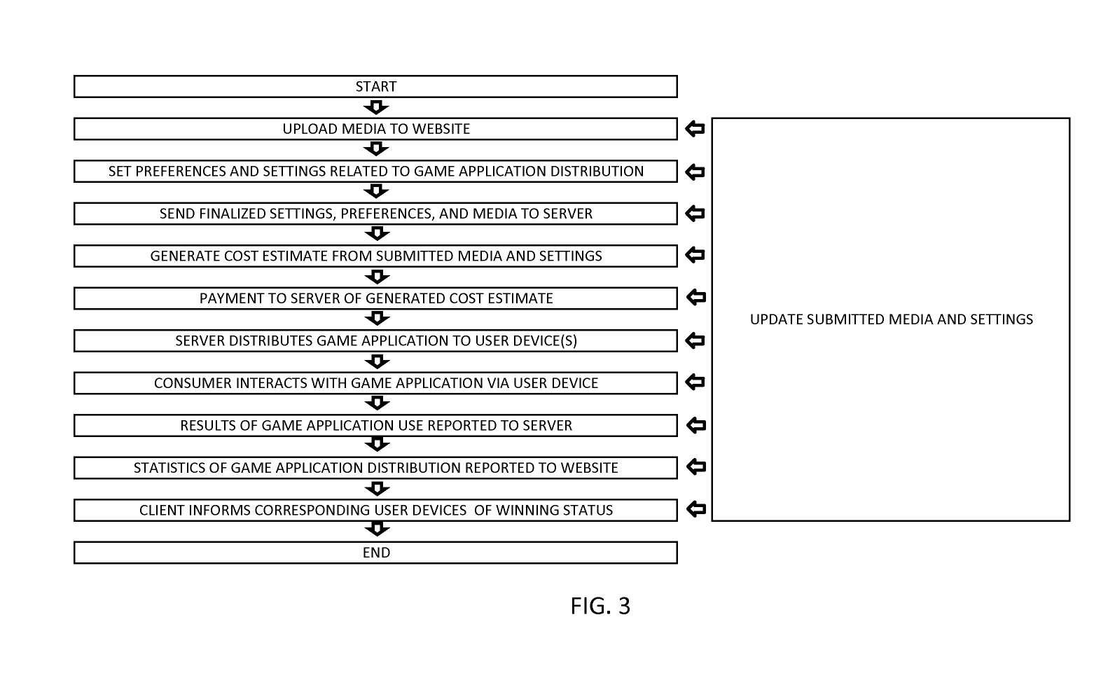

The current invention is a system and method for clients to generate, manage, and send interactive advertising to a plurality of users or consumers. An overview of the system can be seen in FIGS. 1 and 3 which denote the system generally with reference numeral 10 and the most basic order of operations the system 10 performs, respectively. A client 14, a server 16, and a user device 18 interact with one another over a pre-existing communication network such as the internet. The client 14, server 16, and user device 18 may be any device which is capable of accessing the internet which are now known or later devised including computers, smart phones, tablets, and the like. The client 14, server 16, and user device 18 connect to the internet via any known means such as wireless, broadband, cable connections, or any combination thereof.

The server 16 maintains a web site 20 or other access point on the internet which may be accessed by a potential client 14. Using a series of prompts and instructions maintained on the web site 20 as is known in the art, the prospective client 14 submits or uploads a plurality of images, sounds, videos, or other types of suitable media which the client 14 wishes to advertise. Specifically, the client 14 uploads which media the client 14 desires to represent or be disposed at the relative positions of the goal icons 24, scratcher icons 26, prize circle 28, and scratcher card 22 itself as is further detailed below. The client 14 may also through a series of separate prompts on the web site 20 set a number of preferences relating to the intended or target viewer of the submitted media which the client 14 intends to advertise. Such preferences include but are not limited to: age range of a consumer, consumer gender, current location of the consumer, ethnicity of the consumer, profession of the consumer, or the stored preferences submitted by the consumer.

Finally, the client 14 sets a plurality of settings for advertising their submitted media including what type of interface they would prefer their media to be represented in. Preferably, the types of interfaces include different types of game or activities, however any interface known to be used or displayed on traditional electronic devices such as smart phones, tablets, and the like may be used without departing from the original spirit and scope of the invention. For the purposes of this disclosure, “game” refers to any interactive program or software application which allows a consumer to engage and manipulate a series of images displayed on a screen. More preferably, “game” refers an interactive program emulating or approximating a game of chance or luck in the form of a lottery scratcher. While a lottery scratcher is described in detail below, it should be made explicit that other games of chance involving a random number generator such as bingo or a slot machine may also be used without significantly departing from the current invention. The client may dictate the settings relating to the lottery game application including but not limited to I) the odds for a consumer to win or beat the lottery game, II) where the submitted images or sounds are displayed or emanate from related to the context of the lottery game, and III) how many total lottery games may be distributed. Once all the details and settings of the advertising campaign are finalized by the client 14, the web site 20 sends the listing of client 14 selections in the form of a request to the server 16. The server 16, which comprises a CPU or microcontroller as is known in the art, saves the client's 14 request and based upon a predetermined formula or algorithm known in the art, generates a cost estimate which is then sent back to the client 14 over the internet for review. Upon review of the cost estimate, the client 14 then approves of the action to be taken by submitting payment to the server 16 via the web site 20. After payment has been received, the server 16 distributes a plurality of lottery games to a type and number of user devices 18 according to the preferences initially determined by the client 14. The server 16 sends a plurality of completed lottery games to the plurality of user devices 18 which have previously downloaded the lottery game application made available by the server 16. Alternatively, the server 16 may send the lottery game application to a plurality of known user devices 18 via email according to a predetermined listing of user devices 18 as prepared and submitted to the server 16 by the client 14. The user devices 18 download or otherwise open the sent lottery game application on their computer or smart device and then proceed to play or use the lottery game application.

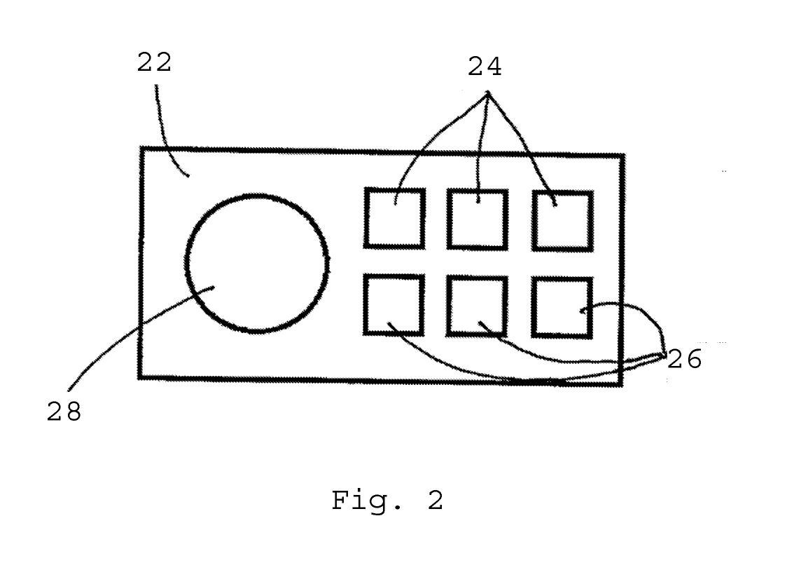

Preferably, the lottery game application takes the form of a lottery scratcher card 22 as seen in FIG. 2. The consumer will have the scratcher card 22 displayed on their device of choice and interact with the scratcher card 22 via a mouse if displayed on a computer or via the user's finger if displayed on a smart phone, tablet, or other similar device. The scratcher card 22 comprises a plurality of goal icons 24 and a corresponding plurality of scratcher icons 26 which are initially obscured from view to the consumer. The consumer then interacts with the scratcher card 22 by clicking, touching, or otherwise manipulating the scratcher icons 26 and revealing the images behind them. If all three revealed images of the scratcher icons 26 match that of the goal icons 24, for example, the consumer wins the prize displayed in the prize circle 28. The images used to comprise the goal icons 24, scratcher icons 26, and the scratcher card 22 itself are all determined by the previously uploaded media received from the client 14. Additionally, the client 14 may also specify the prize which is displayed in the prize circle 28.

After all the scratcher icons 26 have been manipulated, the game is considered complete and the results of the scratcher card 22 are automatically submitted to the server 16 by the user device 18. Information received from the user device 18 including whether or not the scratcher card 22 was a winning card, the time stamp at which scratcher card 22 was used, which images were revealed by the scratcher icons 26, how many scratcher icons 26 matched the goal icons 24, or any other information related to the user device 18 is sent to the server 16 as a series of status indicators and stored on an internal memory drive within the server 16. The server 16 may mark the received status indicator as a winning item when at least three scratcher icons 26 disposed on the scratcher card 22 match at least three goal icons 24 disposed on the scratcher card 22. This data is then accessible to the client 14 via the web site 20, thus giving the client 14 a real time view on how their submitted media is being viewed or consumed. The web site 20 and server 16 also allow the client 14 to update their settings and view the progress of their advertising campaign. For example, the client 14 may log in to the web site 20 and view of how many out of the total number of distributed lottery game applications have been used, which specific uploaded images or media have been viewed and how many times, how many total prizes have been won, among other details.

By saving the results of the lottery game application in the server 16, a progress state associated with the user device 18 may be created allowing the consumer to still accumulate winnings even if they do not successfully complete the lottery game application. For example, if the scratcher icons 26 of the scratcher card 22 do not match or fewer than the total number of goal icons 24, the consumer may still earn credit or points associated with that user device 18. The resulting accounting of earned credit or points are sent to the server 16. Over time, a consumer may accumulate a number of these credits or points which may be used at a future date for additional games distributed by the client 14 such as for example drawings for additional prizes or for more scratcher cards 22.

After the client 14 reviews the statistics related to the game application distribution, the client 14 may be informed as to which scratcher cards 22 contained a winning game and which user device 18 the winning scratcher card 22 is correlated with. The client 14 may then contact the consumer associated with the user device 18 through means not included within the system 10 such as telephone or email and inform them of their winning status and/or deliver the prize which was originally displayed or noted within the prize circle 28. Alternatively, if the prize displayed within the prize circle 28 is credit, points, or other electronic payment, the client 14 may allocate the prize to the consumer's user profile stored on the server 16.

In one particular embodiment as seen in FIG. 3, the client 14 may submit new or updated instructions to the web site 20 which updates or changes their previously made settings related to the game application distribution. For example, the client 14 may add additional images to be displayed on the goal icons 24 and scratcher icons 26 which are then implemented to the scratcher cards 22 by the server 16. The client 14 may update their previous settings at a plurality of points during the game application distribution process as seen in FIG. 3. Upon receipt of the updated settings, the server 16 will generate a new cost estimate if necessary which reflects the adjusted settings and send the new cost estimate to the client 14 for payment. At this point, the game application distribution process continues as before and as previously described above with a plurality of game applications being distributed to a plurality of user devices 18 according to the client's 14 new or updated preferences or settings. A client 14 may repeatedly update or change their preferred settings as many times as desired or as needed.

Many alterations and modifications may be made by those having ordinary skill in the art without departing from the spirit and scope of the embodiments. Therefore, it must be understood that the illustrated embodiment has been set forth only for the purposes of example and that it should not be taken as limiting the embodiments as defined by the following embodiments and its various embodiments.

Therefore, it must be understood that the illustrated embodiment has been set forth only for the purposes of example and that it should not be taken as limiting the embodiments as defined by the following claims. For example, notwithstanding the fact that the elements of a claim are set forth below in a certain combination, it must be expressly understood that the embodiments includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the embodiments is explicitly contemplated as within the scope of the embodiments.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the embodiments.

I claim:

1. A method for distributing interactive advertising comprising:
receiving uploaded media from a client over a computer based network at a server;
receiving a plurality of inputs from the client over the computer based network at the server;
generating a cost estimate based upon the received uploaded media and plurality of inputs by the server;
generating a plurality of interactive advertisements according to the received uploaded media and plurality of inputs by the server; and
distributing the plurality of interactive advertisements to a plurality of user devices according to the plurality of inputs received from the client.

2. The method of claim 1 wherein generating a plurality of interactive advertisements according to the received uploaded media and plurality of inputs comprises generating a plurality of interactive advertisements each comprising:
an interactive scratcher card;
at least one goal icon disposed on the scratcher card;
at least one scratcher icon disposed on the scratcher card; and
at least one prize icon disposed on the scratcher card.

3. The method of claim 2 wherein receiving uploaded media from a client over a computer based network at a server comprises receiving uploaded media which corresponds to the scratcher card, the at least one goal icon, the at least one scratcher icon, or the prize icon.

4. The method of claim 3 wherein generating a plurality of interactive advertisements according to the received uploaded media and plurality of inputs comprises inserting the uploaded media into a pre-selected position designated for the scratcher card, the at least one goal icon, the at least one scratcher icon, or the prize icon.

5. The method of claim 1 wherein receiving a plurality of inputs from the client over the computer based network at the server comprises receiving a plurality of parameters selected by the client related to the plurality of user devices the plurality of interactive advertisements are to be distributed to.

6. The method of claim 5 wherein generating a cost estimate based upon the received uploaded media and plurality of inputs by the server comprises the server automatically generating a cost estimate according to the plurality of parameters selected by the client and sending the generated cost estimate to the client.

7. The method of claim 5 wherein distributing the plurality of interactive advertisements to a plurality of user devices according to the plurality of inputs received from the client comprises distributing the plurality of interactive advertisements to the plurality of user devices according to the received plurality of parameters selected by the client.

8. The method of claim 5 wherein the plurality of parameters selected by the client related to the plurality of user devices comprises at least:
an age range associated with a user of each of the plurality of user devices;
an ethnicity associated with the user of each of the plurality of user devices;
a profession associated with the user of each of the plurality of user devices;
a current physical location associated with the user of each of the plurality of user devices; or
a total number of interactive advertisements which are to be distributed.

9. The method of claim 2 further comprising receiving a status indicator from at least one of the plurality of user devices indicating that at least one scratcher icon disposed on the interactive scratcher card matches at least one goal icon disposed on the scratcher card at the server.

10. The method of claim 9 further comprising the server marking the received status indicator as a winning item when at least three scratcher icons disposed on the scratcher card match at least three goal icons disposed on the scratcher card at the server.

11. The method of claim 10 further comprising the server notifying the client of how many out of the distributed interactive advertisements have been marked as winning items.

12. The method of claim 2 further comprising receiving a second set of uploaded media or a second plurality of inputs from the client over the computer based network at the server and automatically generating a second cost estimate based upon the received second set of uploaded media or second plurality of inputs.

13. The method of claim 12 wherein generating a plurality of interactive advertisements according to the received uploaded media and plurality of inputs comprises inserting the second set of uploaded media into a pre-selected position designated for the scratcher card, the at least one goal icon, the at least one scratcher icon, or the prize icon.

14. The method of claim 12 wherein receiving a plurality of inputs from the client over the computer based network at the server comprises receiving a second plurality of parameters selected by the client related to the plurality of user devices the plurality of interactive advertisements are to be distributed to.

14. The method of claim 12 where generating a cost estimate based upon the received uploaded media and plurality of inputs by the server comprises the server automatically generating a cost estimate according to the second uploaded media or second plurality of inputs selected by the client and sending the generated cost estimate to the client.

15. The method of claim 14 wherein distributing the plurality of interactive advertisements to a plurality of user devices according to the plurality of inputs received from the client comprises distributing the plurality of interactive advertisements to the plurality of user devices according to the received second plurality of parameters selected by the client.
